(19) United States
(12) Patent Application Publication
(10) Pub. No.: US 2021/0199202 A1
(43) Pub. Date: Jul. 1, 2021

(54) Valve For Modulating Flow And Pressure Used In Tubing For The Transportation Of Liquids

(71) Applicants: Sergio Garrido López-Castro, Hermosillo (MX); Guillermo Alfonso Gaxiola Astiazarán, Hermosillo (MX)

(72) Inventors: Sergio Garrido López-Castro, Hermosillo (MX); Guillermo Alfonso Gaxiola Astiazarán, Hermosillo (MX)

(21) Appl. No.: 17/058,081

(22) PCT Filed: May 22, 2019
(86) PCT No.: PCT/MX2019/050010

§ 371 Date: Nov. 23, 2020

(30) Foreign Application Priority Data
May 23, 2018 (MX) MX/A/2018/006360

(51) Int. Cl. F16K 3/34; F16K 3/26

(52) U.S. Cl. CPC F16K 3/34; F16K 3/265

(57) ABSTRACT

The invention relates to a valve for modulating flow and pressure used in tubing for the transportation of liquids, which modulates the flow and pressure of the fluid, preventing the generation of air bubbles and the passage of these through the tubing, thereby preventing them being registered as consumed cubic metres. The valve comprises: two adapters with a female thread on the outer parts of the valve, same containing the internal parts of the valve; a bar having a variable number of perforations or holes, same containing a mobile disk; a mobile disk having a variable number of perforation or holes; a stainless steel screw joined to the mobile disk; and a PVC pipe containing the bar, the mobile disk and the stainless steel screw.

### FIELD OF THE INVENTION

As expressed in the title of this description, the present invention belongs to the field of mechanical, hydraulic and industrial design. The invention relates primarily to the distribution of liquids or fluids in its final stage. The invention relates particularly to a flow and pressure modulation valve used in pipes for transport of liquids.

### OBJECT OF THE INVENTION

The problem to be solved is centered in reducing the generation of air bubbles in the drinking water pipes, mainly, which are recorded as cubic meters consumed and in the case of domestic water distribution, it generates that the receipt arrives, under certain circumstances, up to 50% greater than the amount of water received. At the same time, another object is to present a mechanical and hydraulic design which improves the products of the current market, resulting in a longer useful life, reducing maintenance and modulating the fluid, preventing the liquid meter to register the presence of air when passing through.

### BACKGROUND TO THE INVENTION

Currently, there are certain components, valves or devices which attempt to overcome the problems described above, however, they have been studied and tested, showing multiple deficiencies and problems.

It is to be understood that the pipes carrying liquids have air arriving to the flow meters installed in industry, in dwelling, among other buildings, therefore the meter quantifies that flow. The presence of air is due to many reasons: new pipe installation containing air in its interior, pipe repair, low pressure conditions, among others.

There are some patents in prior art related to the present invention:

The patent document PE1 1562013 (Z)-2013-11-1-02 (Iapatent®), titled an improved saving air discriminator (DAAM valve), referring to a polyvinyl chloride (PVC) hermetic device, which is coupled to the water meters, and comprises: a) an inlet adapter port; b) an outlet adapter port; c) a flow restrictor conduit; d) a sub valve and port of the sub valve; e) a pressure and flow recovery conduit; f) a conduit divider. Said discriminator prevents the ingress of air from the supply lines to the home network, thereby preventing it from being recorded by the metering apparatus and generating an erroneous water consume register.

The patent document MX2008003517 (A)-2008-04-14 (Iapatent®), titled a pneumatic air ejector valve, intended to protect an air ejector valve, which is used mainly in water outlets, that is, by beginning the pumping of water through the pipe, it is filled with air, which forms a body and as it is driven by the water must find output, it is in this air ejector valve where it encounters its vent since these are installed prior to the water meter, allowing free passage of the air and as the flow of water is started, it is closed, allowing the passage of water into the meter.

Patente document MXPA05010981 (A)-2007-04-13 (Iapatent®), titled an air bleed valve with lateral expulsion for intake, which discloses an air bleed valve with lateral expulsion for entry, coupled to the water supply line prior to the fluid meter, characterized by a cylindrical body which forms a flood chamber in which a diffuser element is housed based on two cylindrical sections wherein the lower section has a pair of windows for the passage of air or air water flow and in the upper section has a cap for receiving the spherical seal element; and a lid element with lateral groove for air expulsion or air-water.

Patent PE05402005 (Z)-2005-07-1 1 (Iapatent®), titled air separator for fresh drinking water systems, consisting of: a) a brass box, steel or elliptical section plastic with a threaded hole in the center of the upper generatrix axis of the ellipse, for installing the drinking water inlet connection, and a threaded hole at the top where the air discharge valve is housed; b) a lid of the same section as the box with holes enabling its assembly on the box, using bolts and a sealing element. Said lid has at its lower part a cone whose vertex coincides with the centre of the water ingress connection, a tube vertical to the axis of the cone and to the drainage hole in this, the latter being threaded to allow installation of the separator in the meter line; c) an air discharge valve formed by a body which receives a centering element, such as a plastic ball with a weight such that it allows it to float driven by the pressure of air or the flow of water, with its corresponding sealing elements thereby operating as a double acting valve. This fitting prevents air from the drinking water pipes from entering the meter, causing erroneous readings and meter wear.

The invention also relates to a pair of more patents, however, they are older than those already shown and their information is not relevant to the present invention.

Most of these localized patents have the problem of using metal ejectors, which oxidize and decompose in months. One of the major problems is the short useful life and maintenance required. The maintenance thereof depends on the metal parts, because they oxidize quickly.

As can be appreciated, the prior art patents have variations in design with each other and also have a different reduction in the passage of the air by the flow meters. It can be inferred that none of them have been actually innovative or successful due to their absence in national commerce.

### DESCRIPTION

The present invention discloses a flow and pressure modulation valve used in pipes transporting liquids, which modulates the flow and pressure of the fluid, avoiding the generation of air bubbles and the passage of the latter by the pipes thus avoiding being recorded as consumed cubic meters. This valve is installed after the meter, giving saving results. It solves the problem that all water consumers have, which is the presence of air in drinking water pipes.

The use of this valve can save from 5% to 60% of the water fee payment. This variation is due to the pressure differentials being handled, and thus to the generation of air bubbles. The greater the pressure, the greater the generation of bubbles, then the greater the saving provided by the valve. With the above, it is to be understood that there is no equal savings in every place used, since it depends on the pressure conditions of the liquid in the pipes.

When installing this valve, an air shock is generated by forming a reverse vortex preventing the air from passing with the force in which it comes, transforming them into small bubbles and passing slowly, causing the meter not to record the presence of bubbles as liquid.

The structural elements of the present invention are the following:
a) PVC bar (2).
b) PVC mobile disk or modulator (3).
c) Stainless steel screw (4).
d) Two PVC female fittings (1,6), each at one end of the valve.
e) PVC pipe (5) of ½ to 10 inches. Size depends on the flows to be transported.
f) Special glue for joining the parts of the valve.

PVC material preferably for the bar (2), the pipe (5), the mobile disk (3) and the female fittings (1,6), however, other plastic, composite, ceramic or metallic materials may be used. The glue used should be the same for the type of material to be glued. A special glue for PVC is used for the invention.

In other words, the flow and pressure modulation valve used in liquids for transport of liquids is comprised of: two fittings with a female thread (1, 6) on the external parts of the valve, which contain the internal parts of the valve (2, 3, 4, 5); a bar (2) with a variable number of perforations or bores which contains a mobile disk (3); a mobile disk (3) with a variable number of perforations or bores; a stainless steel screw (4) attached to the mobile disk (3); and a PVC pipe (5) containing the bar (2), the mobile disk (3) and the stainless steel screw (4).

Said structural elements are processed following the steps described below, to obtain the flow and pressure modulation valve used in pipes for liquid transport:
1. The pipe (5) is sized/cut.
2. The bar (2) is sized.
3. The bar (2) is perforated/drilled. The number of perforations depends on the size of the valve.
4. The mobile disk (3) is separated from the bar (5).
5. The holes/perforations are made to the stainless steel screw (4).
6. At any time, the screw (4) may be glued to the mobile disk or modulator (3).
7. The bar is glued (2) in the pipe (5).
8. An end is attached to a fitting (1) and then to the next one (6).

### BRIEF DESCRIPTION OF THE DRAWINGS

FIG. 1.—Isometric view of the flow and pressure modulation valve used in pipes for transporting liquids.

FIG. 2.—Side view of the flow and pressure modulation valve used in pipes for transporting liquids.

FIG. 3.—Lower view (outlet) of the flow and pressure modulating valve used in pipes for transporting liquids.

FIG. 4.—Exploded view of the flow and pressure modulation valve used in pipes for transporting liquids.

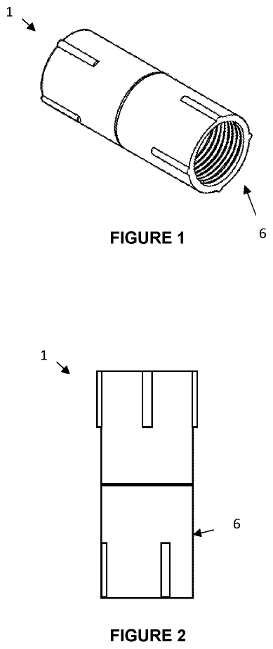

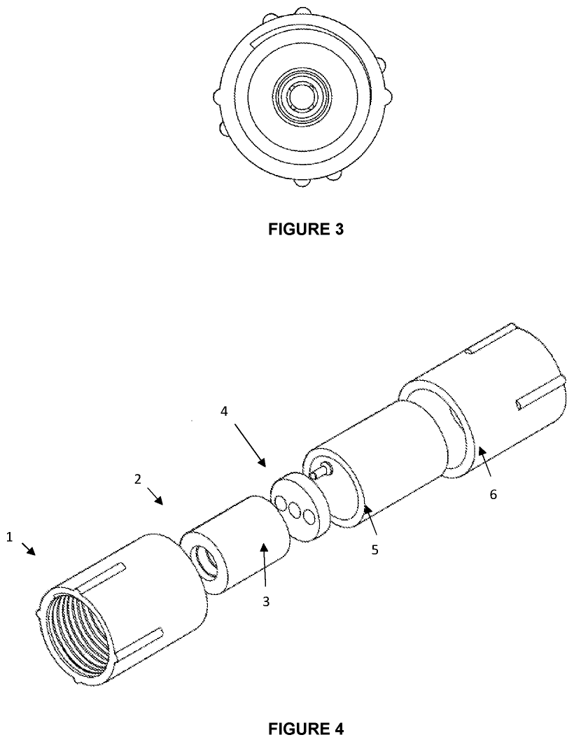

### DETAILED DESCRIPTION/PREFERRED EMBODIMENT

The flow and pressure modulation valve used in pipes for transporting liquids is next described in detail. It should be noted that the description, detailed description, and preferred embodiment of the invention do not exclude other possible configurations or applications of the valve described herein.

In order to avoid confusion with the drafting, the names of the parts of the flow and pressure modulating valve used in pipes for transporting liquids, with numbering as shown in the accompanying drawings, are presented below:
(1) Female threaded fitting.
(2) PVC bar.
(3) Mobile disk or modulator.
(4) Stainless steel screw.
(5) PVC pipe.
(6) Female threaded fitting.

The female threaded fittings (1, 6) have the function to be the outer part which cover and protect the bar (2), the pipe (5), the mobile disk (3) and the screw (4). The female threaded fittings (1, 6), in turn, serve to adapt the valve to the pipes of drinking water or some other liquid of interest.

The PVC bar (2) is drilled/perforated inside to allow liquids to flow, where said perforations are strategically performed to prevent air bubbles from being generated, allowing only liquids to pass in its entirety. The invention prevents the meter from recording an excess of water (liquids) consumption due to the presence of air.

The perforations or bores are preferably staggered to prevent the generation of bubbles. The drilled volume varies according to the diameter of the pipe.

The mobile disk or modulator (3), with a number of perforations or bores allows regulating the flow of liquids depending on the circumstances of the area where it is installed. The perforations or bores are preferably staggered to prevent the generation of bubbles. The drilled volume of the mobile disk or modulator (3) varies according to the diameter of the valve.

Said mobile disk (3) serves to avoid making various models of the valve, and thus encompass the needs in zones with different water delivery pressure. For example, at a location where there is a higher pressure, a non disk valve would function without problems; however, if the pressure would be decreased, the contact area must be increased, and this mobile disk (3) helps with this without the need to manufacture another valve model of the same diameter.

The mobile disk (3) is fixed to the PVC bar (2) by means of a stainless steel screw (4). This screw (4) allows the mobile disk (3) to change in position when required, according to the system pressure conditions.

The PVC pipe (5) has the function to contain the PVC bar (2), the mobile disk (3) and the stainless steel screw (4). At the same time, this pipe (5) is contained by the female threaded fittings (1, 6). A special glue for PVC is used for the joint between these structural elements.

Finally, after having described each part, their functions and advantages, it is of sum importance to highlight the fact that using such structural technical configurations provide advantages much superior to the state of the current art.

It is to be understood that the description and embodiments described herein are merely illustrative of the present preferred embodiments of the invention, and that there are no limitations intended by the details of construction or design herein, which is not as described in the appended claims. Modifications may be made which may result after having taken into account the present specification, as well as other uses which may be presented to those mentioned herein.

Having described clear and sufficiently my invention, I consider as a novelty and therefore I claim as my exclusive property, the content of the following claims:

1. A flow and pressure modulation valve used in tubing for transporting liquids, comprising two fittings with a female thread (1, 6) on the external parts of the valve, which contain the internal parts of the valve; a bar (2) with a variable number of perforations or bores and which contain a mobile disk (3); a mobile disk (3) with a variable number of perforations or bores; a stainless steel screw (4) attached to the mobile disk; and a PVC pipe (5) containing the bar (2), the mobile disk (3) and the stainless steel screw (4).

2. The flow and pressure modulation valve used in tubing for transporting liquids according to claim 1, wherein said valve modulates the flow and pressure of the fluid, preventing the generation of air bubbles and the passage of the latter by the pipes thus avoiding being recorded as consumed cubic meters.

3. The flow and pressure modulation valve used in tubing for transporting liquids according to claim 2, wherein the perforated volume of the bar (2) and the mobile disk (3), varies according to the diameter of the pipe.

4. The flow and pressure modulation valve used in tubing for transporting liquids according to claim 3, wherein the perforations or bores of the bar (2) and mobile disk (3) are staggered, which helps to prevent the generation of air bubbles.

5. The flow and pressure modulation valve used in tubing for transporting liquids according to claims 2 and 4, wherein the screw (4) allows the mobile disk (3) to be changed in position when required, depending on the pressure conditions of the system.

6. The flow and pressure modulation valve used in tubing for transporting liquids according to claim 1, wherein the bar (2), the pipe (5), the mobile disk (3) and the female fittings (1, 6) are made of PVC preferably, however, other plastic, composite, ceramic or metallic materials can be used.

7. The flow and pressure modulation valve used in tubing for transporting liquids according to claim 1, wherein the fabrication process comprises: a) Sizing/cutting the pipe (5); b) Sizing/cutting the bar (2); c) Cutting/drilling the bar (2); d) Separating the mobile disk (3) or modulator of the bar (5); e) Perforating the stainless steel screw (3); f) At any time, gluing the screw (4) to the mobile disk (3); g) Gluing the bar (2) into the pipe (5); h) Gluing an end with a fitting with a female thread (1) and then the next one (6).
